(19) United States
(12) Patent Application Publication
(10) Pub. No.: US 2013/0105737 A1
(43) Pub. Date: May 2, 2013

(54) ZINC SULFIDE BLUE PHOSPHOR AND A METHOD FOR PRODUCING THE SAME

(71) Applicants: Keiji Ono, Iwaki-shi (JP); Akihumi Sano, Iwaki-shi (JP); Hiroki Nagayoshi, Iwaki-shi (JP); Keita Kobayashi, Sakai-shi (JP); Satoshi Komori, Sakai-shi (JP); Atsuki Terabe, Iwaki-shi (JP); Yosuke Akahori, Kurashiki-shi (JP); Kazuma Inoue, Kurashiki-shi (JP); Hideharu Iwasaki, Kurashiki-shi (JP)

(72) Inventors: Keiji Ono, Iwaki-shi (JP); Akihumi Sano, Iwaki-shi (JP); Hiroki Nagayoshi, Iwaki-shi (JP); Keita Kobayashi, Sakai-shi (JP); Satoshi Komori, Sakai-shi (JP); Atsuki Terabe, Iwaki-shi (JP); Yosuke Akahori, Kurashiki-shi (JP); Kazuma Inoue, Kurashiki-shi (JP); Hideharu Iwasaki, Kurashiki-shi (JP)

(73) Assignee: SAKAI CHEMICAL INDUSTRY CO., LTD., Sakai-shi (JP)

(21) Appl. No.: 13/697,126

(22) PCT Filed: May 11, 2011
(86) PCT No.: PCT/JP11/60843

§ 371 Date: Jan. 10, 2013

(30) Foreign Application Priority Data
May 14, 2010 (JP) 2010-112274

(51) Int. Cl. C09K 11/60; C09K 11/58

(52) U.S. Cl. CPC C09K 11/60; C09K 11/58
USPC 252/301.6 S

(57) ABSTRACT

Zinc sulfide phosphor that has high energy efficiency and color purity and that emits blue light is provided. Specifically, a zinc sulfide phosphor adapted for use as a light source or in a display by being applied to powder EL elements is provided. The zinc sulfide blue phosphor comprises copper, silver or both elements and nickel, iron or both elements. The phosphor is obtained by adding a compound comprising copper, silver or both elements, a zinc compound, a sulfidizing agent and a compound comprising nickel, iron or both elements as an aqueous solution to an organic solvent to form a reaction mixture, heating the mixture and removing water from the reaction mixture by azeotropic dehydration of water and the organic solvent to obtain a zinc sulfide phosphor precursor, further sintering the zinc sulfide phosphor precursor.

### TECHNICAL FIELD

The present invention relates to a phosphor that is advantageous for use in a powder electroluminescent (EL) element.

### BACKGROUND ART

Inorganic compositions comprising compound semi-conductors as main components are used in fields of luminescent materials, which emit fluorescence, phosphorescence and the like, and light-storing materials. Some such compositions, which emit light by using electric energy, are used as a light source and partly in displays. A phosphor that emits blue light is useful not only as a luminescent material emitting blue light alone but also as a luminescent material emitting white light. However, currently known materials are limited in their usage due to their poor electric energy-to-light conversion efficiency that induces undesirable heat development and power consumption.

Some zinc sulfide (ZnS) phosphors, composed mainly of zinc sulfide, are known to emit blue light. Examples of such ZnS phosphors are zinc sulfide phosphors doped with copper (refer to non-patent document 1, for example) and those doped with thulium (Tm) (refer to non-patent document 2, for example). Other examples are zinc sulfide prepared under hydrothermal conditions (refer to patent document 1, for example), and those using praseodymium as a dopant (refer to non-patent document 3, for example).

### CITATION LIST

### Patent Documents

PATENT DOCUMENT 1: Japanese Patent Publication No. 2005-36214 A

### Non-Patent Documents

NON-PATENT DOCUMENT 1: Journal of Luminescence 99 (2002) 325-334.
NON-PATENT DOCUMENT 2: Journal Non-Crystalline Solids 352 (2006) 1628-1631.
NON-PATENT DOCUMENT 3: Japanese Journal of Applied Physics Vol. 44 No. 10, 2005, 7694-7697.

### SUMMARY OF INVENTION

### Technical Problem

However, conventionally known zinc sulfide phosphors that emit blue light have low energy efficiency and color purity, so it was difficult to use them as a light source or in a display; various solutions to these problems, such as using a large amount of compounds comprising expensive rare earth elements or adding other elements with sensitizing effects, were considered. However, no solution that fulfills both energy efficiency and color purity is found.

Further, a conventional zinc sulfide blue phosphor has y value larger than 0.16 and the blue ingredient content of the phosphor is small, so the phosphor will have only a small color rendering property when it is whitened, and common whitening fluorescent agents cannot reproduce pure white; hence, usages were limited.

### Solution to Problem

The present inventors found that the above problem can be solved by doping at least one of the elements, nickel and iron, which should be eliminated as much as possible from the view point of luminescence efficiency, to zinc sulfide phosphors comprising at least one of copper (Cu) and silver (Ag) and thus, they achieved the present invention.

That is, the present invention provides the following solutions.

[1] A zinc sulfide blue phosphor comprising copper, silver or both elements, and nickel, iron or both elements.
[2] The zinc sulfide blue phosphor according to [1] wherein a content of nickel is not lower than 0.1 ppm and not higher than 20 ppm.
[3] The zinc sulfide blue phosphor according to either [1] or [2] wherein a content of iron is not lower than 0.1 ppm and not higher than 50 ppm.
[4] The zinc sulfide blue phosphor according to any one of [1] to [3] wherein a powder EL element is composed of a phosphor, and a y value of an emission color when the elements are driven at 200V and 1 kHz is 0.07≦y≦0.16.
[5] A method for producing zinc sulfide blue phosphor according to any one of [1] to [4] comprising: adding a compound comprising copper, silver or both elements, a zinc compound, a sulfidizing agent and a compound comprising nickel, iron or both elements as one or more aqueous solutions to an organic solvent to form a liquid reaction mixture, then heating the reaction mixture and removing water from the reaction mixture by azeotropic dehydration of water and the organic solvent and to obtain a zinc sulfide phosphor precursor, and further sintering the zinc sulfide phosphor precursor.

### Advantageous Effects of Invention

The present invention provides zinc sulfide phosphor that has high energy efficiency and color purity and that emits blue light. The zinc sulfide phosphor is adapted for use as a light source and a display as a phosphor component of a powder type EL device. Further, the production method of the present invention can produce a phosphor precursor compound uniformly doped with active metal, and consequently, provides a zinc sulfide phosphor that has high energy efficiency and color purity and that emits blue light.

### DESCRIPTION OF EMBODIMENTS

The present invention is described in detail below.

The production method of zinc sulfide blue phosphor of the present invention comprises adding a compound comprising copper, silver or both elements, a zinc compound, a sulfidizing agent and a compound comprising nickel, iron or both elements as one or more aqueous solutions to an organic solvent to form a liquid reaction mixture, then heating the reaction mixture and removing water from the reaction mixture by azeotropic dehydration of water and the organic solvent to obtain a zinc sulfide phosphor precursor, and further sintering the zinc sulfide phosphor precursor.

Zinc compounds used in the production method of the present invention may include mineral acid salts, such as that of hydrochloric acid, sulfuric acid, nitric acid and phosphoric acid; organic acid salts, such as that of formic acid, acetic acid, butyric acid and oxalic acid; and complex salts, such as acetylacetonate. It is preferable to use chlorides in view of stability and persistence after removal of water from the solvent in the reaction mixture by azeotropic dehydration of water and organic solvent. The above compounds can be used alone or as a combination of compounds.

Sulfidizing agents used in the production method of the present invention may include hydrogen sulfide, a hydrogen sulfide-ammonia complex (e.g. ammonium sulfide, ammonium hydrogensulfide, ammonium polysulfide), thioacetamide, thiourea. It is preferable to use a hydrogen sulfide-ammonia complex in view of stability and persistence after removal of water from the solvent in the reaction mixture by azeotropic dehydration of water and organic solvent. The above agents can be used alone or as a combination of compounds.

The compounds comprising copper, silver or both elements, used in the production method of the present invention, are water-soluble compounds. Examples may include the following salts of copper, silver or both elements: mineral acid salts, such as that of hydrochloric acid, sulfuric acid, nitric acid and phosphoric acid; organic acid salts, such as that of formic acid, acetic acid, butyric acid and oxalic acid; and complex salts, such as acetylacetonate. It is preferable to use a hydrochloric acid salt or a sulfuric acid salt in view of stability and persistence after removal of water from the solvent in the reaction mixture by azeotropic dehydration of water and organic solvent. The above agents can be used alone or as a combination of compounds.

A donor element (such as chlorine, bromine, iodine, aluminum, gallium, indium or other elements) to an acceptor element (such as copper, silver or both elements) may be appropriately incorporated into the zinc sulfide phosphor precursor by presenting compounds containing such the donor element in the aqueous solution.

The compounds comprising nickel, used in the production method of the present invention (hereinafter referred to as nickel compounds), are water-soluble compounds. Further, the compounds comprising iron, used in the production method of the present invention (hereinafter referred to as iron compounds) are water-soluble compounds. Examples may include the following salts of nickel, iron or both elements; mineral acid salts, such as that of hydrochloric acid, sulfuric acid, nitric acid and phosphoric acid; organic acid salts, such as formic acid, acetic acid, butyric acid and oxalic acid; and complex salts, such as acetylacetonate. It is preferable to use a hydrochloric acid salt or a sulfuric acid salt in view of stability and persistence after removal of water from the solvent in the reaction mixture by azeotropic dehydration of water and organic solvent. The above agents can be used alone or as a combination of compounds.

There is no particular limitation on the procedure for introducing copper, silver or both elements and iron, nickel or both elements to the zinc sulfide but the following procedures are commonly used: mixing solids of a compound comprising copper, silver or both elements, and a nickel compound and/or an iron compound, then sintering the mixture; or dispersing zinc sulfide in water, adding a compound comprising copper, silver or both elements, and a nickel compound and/or an iron compound, which are dissolved in water, evaporating water from the mixture while stirring, then heating and sintering the mixture. Another procedure of introducing copper, silver or both elements coexist with a nickel compound and/or an iron compound into a compound in the reaction field for generating zinc sulfide, in other words, a process of introducing into a compound, copper, silver or both elements coexist with a zinc compound, a sulfidizing agent, and a nickel compound and/or an iron compound, in an aqueous solution to form a sulfide, may be used in the present invention. Further, an uneven dispersion of nickel and/or iron holds a high possibility of significantly reducing the fluorescence quantum yield of zinc sulfide phosphor and the luminescence efficiency of zinc sulfide phosphor when the phosphor is used as a powder inorganic EL element, so it is preferable to use a procedure that induces a highly uniform dispersion. In view of the above viewpoint, it is most preferable to use the procedure of adding an aqueous solution of a compound comprising copper, silver or both elements, a zinc compound, a sulfidizing agent, and a nickel compound and/or an iron compound to an organic solvent to form a liquid reaction mixture, then heating the reaction mixture and inducing azeotropy of water and organic solvent, collecting only water condensed from the resultant vapor to remove water from the reaction mixture, thereby forming the desired zinc sulfide phosphor precursor in the reaction mixture.

The reaction speed of a compound comprising copper, silver or both elements, a zinc compound, and a compound comprising nickel, iron or both elements with a sulfidizing agent may vary greatly depending on the type of ingredients used. It is preferable under such situation to separately add an aqueous solution of a sulfate agent and an aqueous solution of other ingredients to the organic solvent and then mix the solutions in the organic solvent, or to mix the aqueous solution of a sulfidizing agent and the aqueous solution of other ingredients with each other immediately before adding the solutions to the organic solvent.

Impurities in water used to dissolve zinc compound, a sulfidizing agent and other ingredients react with the zinc sulfide phosphor precursor and restrict its usage, so an ion exchanged water with an ash content of 100 ppm or lower, more preferably 10 ppm or lower, is commonly used in the production method of the present invention.

The concentration of a zinc compound in the aqueous solution in the production method of the present invention is not particularly limited, since it is not a factor that decreases the uniformity of the zinc sulfide phosphor precursor for a completely dissolved zinc compound. However, an excessively high concentration is not preferable because zinc sulfide phosphor precursor will precipitate and inhibit reaction and thus reduce the reaction speed; meanwhile, an excessively low concentration is not preferable because the volumetric efficiency of the reaction system will decrease greatly. Accordingly, the aqueous solution of a zinc compound is prepared to a concentration in the range of 0.01 to 2 mol/L, more preferably 0.1 to 1.5 mol/L.

The amount of the compound comprising element acting as the donor element (such as chlorine, bromine, iodine, aluminum, gallium, indium or other elements) to the acceptor element (such as copper, silver or both elements) and the compound comprising copper, silver or both elements to be used in the production method of the present invention should preferably be, as a metal element to be doped, in the range of 0.1 to 150,000 ppm, more preferably 1 to 50,000 ppm based on the weight of the obtained zinc sulfide phosphor precursor; the amount should preferably be in the range of 2 to 10,000 ppm in view of the resultant effect and economy. It is preferable to use these compounds comprising such elements by dissolving them in an aqueous solution that has a zinc compound previously dissolved in it.

The amount of nickel compound and/or iron compound to be used in the production method of the present invention is quite important since it affects the fluorescence property of the zinc sulfide phosphor. An excessively high amount of use greatly reduces the fluorescent property of the phosphor and makes it difficult to use the obtained product as a zinc sulfide phosphor. On the other hand, the effects of the present invention may not be obtained when the amount of use is too low, because the compounds will not affect the feature of zinc sulfide phosphor. The weight of nickel to be doped should preferably be in the range of 0.1 to 20 ppm, more preferably in the range of 0.15 to 15 ppm based on the weight of the obtained zinc sulfide phosphor precursor; the weight should more preferably be in the range of 0.2 to 10 ppm in view of the resultant effect and economy. The weight of iron to be doped should preferably be in the range of 0.1 to 50 ppm, more preferably in the range of 0.2 to 30 ppm based on the weight of the obtained zinc sulfide phosphor; the weight should most preferably be in the range of 0.5 to 20 ppm in view of the resultant effect and economy.

It is unclear why the energy efficiency and color purity of zinc sulfide phosphor improves when zinc sulfide phosphor is doped with nickel, iron or both elements, but an explanation can be provided as follows. Most zinc sulfide phosphors comprise an energy transfer route to the luminescent center of blue emission and other light emission routes at the same time. It is thought that the doping of zinc sulfide phosphor with nickel and/or iron inhibits light emission routes other than that of the blue light, and the inhibited energy is mostly converted to heat, thus achieving high blue purity. Although most luminescence energy other than that for blue emission is converted to heat, some inhibited by nickel and/or iron are put to use in blue emission and thus provide high energy efficiency.

A sulfidizing agent used in the production method of the present invention can be contained in any amount constituting a molar ratio of 0.5 to 5 to the amount of zinc element, but generally speaking, a molar ratio in the range of 1.0 to 4 is preferable and a molar ratio in the range of 1.1 to 2 is more preferable, since zinc metal remaining in the reaction system without being reacted may cause undesirable effects in the reaction; it may also cause a decreased color purity and restricted usage for the resultant zinc sulfide phosphor.

The concentration of a sulfidizing agent in the aqueous solution in the production method of the present invention is not particularly limited, since it is not a factor that decreases the uniformity of the zinc sulfide phosphor precursor for a completely dissolved sulfidizing agent. However, an excessively high concentration is not preferable because the sulfidizing agent that has not reacted will precipitate and remain in the target object; meanwhile, an excessively low concentration is not preferable because the volumetric efficiency of the reaction system will decrease greatly. Accordingly, the aqueous solution of a sulfidizing agent should preferably be in the range of 0.01 to 2 mol/L, more preferably in the range of 0.1 to 1.5 mol/L.

Any organic solvent that can form an azeotrope with water to remove water from the reaction system can be used as an organic solvent of the production method of the present invention. Examples may include saturated hydrocarbon such as hexane, cyclohexane, heptane, octane, cyclooctane, nonane, decane, dodecane, cyclododecane, undecane; aromatic hydrocarbon such as toluene, xylene, mesitylene; halogenated hydrocarbon such as carbon tetrachloride, 1,2-dichloroethane, 1,1,2,2-tetrachloroethylene; halogenated aromatic hydrocarbon such as chlorobenzene, dichlorobenzene; ethers such as dibutyl ether, diisobutyl ether, amyl ether, diisoamyl ether, dihexyl ether, dicyclohexyl ether, dioctyl ether, dicyclooctyl ether, anisole, phenyl ethyl ether, phenyl propyl ether, phenyl butyl ether; alcohols such as butyl alcohol, amyl alcohol, isoamyl alcohol, hexyl alcohol, heptyl alcohol, octyl alcohol, cyclooctyl alcohol; esters such as butyl acetate, amyl acetate, isoamyl acetate, butyl butyrate, amyl butyrate, isoamyl butyrate, methyl benzoate, ethyl benzoate. It is preferable to use saturated hydrocarbon or aromatic hydrocarbon in view of the stability and safety of organic solvent, the efficiency of removing water, and its loss due to the dissolution of the obtained zinc sulfide phosphor precursor and the ingredients. Decane, dodecane and xylene are especially preferable.

The amount of organic solvent to be used is not particularly limited, as long as it remains larger than the amount of an aqueous solution containing a dissolved zinc compound and an aqueous solution of a sulfidizing agent added to the former solution.

The production method of the present invention can be implemented at a range of 30 to 300° C. It should be implemented preferably at a range of 40 to 230° C., which is a range that does not require any special experiment facility, a reactor or the like, in view of safety and operability, more preferably at a range of 60 to 200° C. in view of the sulfidizing agent decomposition speed, and even more preferably at a range of 80 to 180° C.

The production method of the present invention should be implemented preferably under inert gas such as nitrogen and argon, since side reaction such as oxidation of the products may not be fully regulated if there is oxygen in the system.

The production method of the present invention should preferably adopt a procedure comprising a step of preparing a reaction mixture by adding aqueous solution of compounds of ingredients to the organic solvent accompanied by a step of removing water from the reaction mixture by azeotropic dehydration of water and organic solvent. Precipitates of zinc sulfide phosphor precursor that forms in the reaction mixture is separated from the liquid phase, and heated and dried under reduced pressure as necessary.

Zinc sulfide phosphor precursor can be dried at a range of 10 to 200° C., but the drying may be accompanied by oxidization of the precursor when a small amount of water exists, especially when drying at high temperature; thus, zinc sulfide phosphor precursor should be dried preferably at 150° C. or lower, and more preferably at a range of 30 to 120° C.

Zinc sulfide phosphor precursor is sintered to prepare zinc sulfide phosphor in the production method of the present invention. The sintering temperature is not lower than the temperature at which the crystal form of zinc sulfide changes and not higher than the sublimation temperature; the sintering temperature is specifically 500 to 1250° C., preferably 550 to 1200° C., and more preferably 600 to 1150° C.

The rate of temperature increase to the sintering temperature is normally 2.0 to 40.0° C./min. An excessively high rate is not preferable because the furnace body or the container to store the zinc sulfide phosphor precursor will break; an excessively slow rate is not preferable because the production efficiency will decrease significantly. Accordingly, a preferable rate of temperature increase is 2.5 to 30.0° C./min.

The atmosphere for sintering in the present invention is not particularly limited; it can be under any gas atmosphere such as air, an inert gas atmosphere, or a reducing gas atmosphere.

A flux may be used in the production method of the present invention to advance crystallization of zinc sulfide phosphor and increase particle size during sintering. Flux that can be used may include alkali metal salts such as sodium chloride and potassium chloride; alkali earth metal salts such as magnesium chloride and calcium chloride; and zinc chloride. These fluxes can be used alone or as a combination of agents. When a flux is used, the amount of its use is not particularly limited, but an amount in the range of 0.1 to 60 wt % to zinc sulfide phosphor precursor is preferable, and an amount in the range of 0.5 to 50 wt % is more preferable in view of operability and economy.

Sulfur may be added in the present invention to supplement sulfur that is lost during sintering. When sulfur is added, the amount to be added is not particularly limited, but an amount in the range of 0.1 to 300 weight parts or in the range of 1 to 200 weight parts to 100 weight parts of zinc sulfide phosphor precursor is preferable.

Zinc sulfide phosphor, which is the sintered product, is washed after sintering ends in the production method of the present invention. Metal elements excluded from crystal growth and an excess of flux that was added are removed by washing. Neutral water and acidic water may be used for washing. The acidic ingredient to be used is not particularly limited, and mineral acids such as hydrochloric acid, sulfuric acid, nitric acid, phosphoric acid and organic acids such as acetic acid, propionic acid, butyric acid may be used. These acids can be used alone or as a combination of acids. When acidic water is used, it should preferably be an aqueous solution of 0.1 to 20 wt %, more preferably an aqueous solution of 1 to 10 wt %, since zinc sulfide phosphor may decompose when it comes in contact with high concentration acids. It is preferable to use an acetic acid or hydrochloric acid in view of the decomposition of zinc sulfide phosphor and the persistence of ion on its surface.

Sintering may be repeated multiple times after putting strain on the crystal by appropriately adding impact to the zinc sulfide phosphor precursor in the production method of zinc sulfide phosphor of the present invention. It is common to set the last sintering temperature to be the lowest in multiple repetitions of sintering. A compound comprising copper, silver or both elements and a compound comprising zinc may be added when sintering is repeated multiple times. The type of compounds comprising zinc to be used is not particularly limited, and examples may include the following salts of zinc; mineral acid salts such as that of hydrochloric acid, sulfuric acid, nitric acid, phosphoric acid; organic acid salts such as that of formic acid, acetic acid, butyric acid, oxalic acid; and complex salts such as acetylacetonate. The amount of compounds comprising zinc to be used is not particularly limited, and such compounds are added normally in an amount in the range of 10 ppm to 50 wt %, and preferably in the range of 100 ppm to 30 wt % to zinc sulfide phosphor precursor.

When sintering is repeated multiple times in the production method of zinc sulfide phosphor of the present invention, the final sintering is performed at a temperature in the range of 500 to 900° C., preferably in the range of 600 to 850° C. Sintering can be performed under an atmosphere of air, inert gas or reducing gas.

When sintering is repeated multiple times to add a compound comprising copper, silver or both elements and a compound comprising zinc, an excess of the added compounds are washed away as unnecessary metal ingredients after sintering has ended. Other unnecessary metal ingredients, such as precipitates of copper that formed on the surface, can be removed by the wash. Neutral water, acidic water and oxidative water can be used in the wash. Acid ingredients to be used in the acidic water is not particularly limited, and examples include mineral acids such as hydrochloric acid, sulfuric acid, nitric acid, phosphoric acid and organic acids such as acetic acid, butyric acid. These acids can be used alone or as a combination of acids. Oxidative water may be used to improve the removal efficiency of unnecessary metal ingredients. Oxidation ingredients to be used in oxidative water may include organic peroxides such as hydrogen peroxide, persulfuric acid, peracetic acid and salts thereof, t-butyl hydroperoxide. Additionally, ammonia and amines may be used to improve the removal efficiency of unnecessary metal ingredients. Amines that may be used may include methyl amine, ethyl amine, ethylenediamine, ethylenediaminetetraacetic acid (EDTA), 8-quinolinol. These components can be used alone or as a combination of components. When acidic water or oxidative water is used, it should normally and preferably be an aqueous solution of 0.05 to 10 wt %, and more preferably an aqueous solution of 0.1 to 5 wt %. It is preferable to use a hydrochloric acid or an acetic acid as an acid ingredient, and a hydrogen peroxide or peracetic acid as an oxidation ingredient in view of the decomposition of zinc sulfide phosphor and the persistence of ion on the surface of zinc sulfide phosphor.

It is preferable to wash the obtained zinc sulfide phosphor by an ion-exchanged water after washing it with an acidic water or an oxidative water to remove excesses of metal and ion adsorbed to the surface of zinc sulfide phosphor. Ion-exchanged water with ash content not higher than 100 ppm, more preferably ash content not higher than 10 ppm is normally used.

Zinc sulfide phosphor is dried by heating, under reduced pressure, as necessary. Zinc sulfide phosphor precursor can be dried normally at a temperature in the range of 10 to 200° C., but the drying may be accompanied by oxidization of the precursor when a small amount of water exists, especially when drying at high temperature; thus, zinc sulfide phosphor should be dried preferably at 150° C. or lower, and more preferably at 30 to 120° C.

An appropriately formed zinc sulfide phosphor can be confirmed by measuring the fluorescence quantum yield. The fluorescence quantum yield is the proportion of the number of photons emitted by the excitation of the incident light and the number of photons of the incident light absorbed by the substance. A higher value indicates a greater doping effect. The fluorescence quantum yield can be measured by the fluorospectrophotometer.

### EXAMPLES

The present invention is specifically described by the Examples without being limited thereby.

A fluorospectrophotometer of the following measurement condition was used to measure the fluorescence quantum yield.

Measurement instrument: FP-6500 produced by JASCO Corporation

Excitation Wavelength: 350 nm

Excitation Bandwidth: 5 nm

Software: Spectra Manager for Windows™ 95/NT Ver 1.00.00 2005 produced by JASCO Corporation

### Example 1

Zinc chloride anhydride of 136.3 g (1 mol), 0.19 g of copper sulfate pentahydrate (corresponding to 500 ppm of Cu) and 2.2 mg of nickel sulfate hexahydrate (corresponding to 5 ppm of Ni) were dissolved in 500 g of ion-exchanged water to prepare an aqueous solution. Meanwhile, 240.8 g of ammonium sulfide solution (40 wt %, produced by Wako Pure Chemical Industries, Ltd.) was dissolved in 500 g of ion-exchanged water to prepare an aqueous solution. To a three-necked flask of 5 L equipped with a Dean-Stark apparatus, a condenser, a thermometer, and a mixer, 2000 ml of decane was added and then the flask was purged with nitrogen gas. After raising the temperature of decane in the reactor to 120° C., reaction was advanced through separately adding an aqueous solution comprising zinc chloride, copper sulfate and nickel sulfate and an aqueous solution of ammonium sulfide, each at 100 ml/hr, and simultaneously removing distilled water using the Dean-Stark apparatus. It took about 6 hours to feed the whole aqueous solution and an additional 60 minutes to remove water in the system. After the product was cooled to room temperature, the precipitate of sulfide settled down and decane was removed, then the product was dried in a vacuum drier with a vacuum of 1.3 kPa or lower, at 100° C., for 12 hours to collect zinc sulfide phosphor precursor as a white solid. The amount of collected zinc sulfide phosphor precursor was 89.67 g, which was 92% the theoretical amount. The result of ICP analysis of the amount of introduced copper and nickel is shown in Table 1.

To 27 g of the obtained zinc sulfide phosphor precursor, 1.00 g of potassium chloride, 1.17 g of sodium chloride and 6.87 g of magnesium chloride hexahydrate were added and all ingredients were mixed in a ball mill. The mixture was put in a furnace, and the temperature was raised by 400° C./hr in air. When the temperature within the furnace reached 500° C., the gas to be introduced was switched from air to nitrogen, and the temperature was further raised by 400° C./hr to 1050° C. and maintained at 1050° C. for 3 hours. Then, the temperature was lowered by 300° C./hr to room temperature.

The sintered product was added to 200 g of a 5% hydrochloric acid and dispersed. Supernatant liquid was removed from the liquid dispersion by decantation. The remainder was washed with 500 g of ion-exchanged water until it was neutral to obtain the first sintered product. After ion-exchanged water was removed by decantation, the remainder was dried under a vacuum of 1.3 kPa or lower, at 100° C., for 12 hours to obtain 24 g of the first sintered product.

Ion-exchanged water of 200 g was added to 20 g of the first sintered product, and the first sintered product was applied with 3 sets of a supersonic vibration at an output of 60%, wherein 1 set of the supersonic vibration consists of 5 minutes of continual irradiation and 5 minutes of no irradiation, in a supersonic vibrator (Digital Sonifier, produced by BRANSON). Particulates from the crush were removed by passing them through a sieve of 10 μm mesh. The obtained particles were removed from the ion-exchanged water by filtration, and dried under a vacuum of 1.3 kPa or lower at 100° C. for 12 hours.

The above dried product of 10 g was mixed together with 0.25 g of copper sulfate pentahydrate, and 2.5 g of zinc sulfate heptahydrate, and put in a crucible, which was transferred to a furnace. Then, the temperature of the furnace was raised by 400° C./hr under a nitrogen atmosphere. After the temperature had been raised, and the furnace temperature reached 800° C., the gas to be introduced was switched from nitrogen to air, and the introduction of air was continued for an hour while maintaining the furnace temperature. Then, the gas to be introduced was switched from air to nitrogen, and the temperature was maintained for 2 more hours before cooling to 300° C. by 500° C./hr, and then to room temperature by 50° C./hr.

The sintered product was dispersed in 100 g of 5% hydrochloric acid and washed. The supernatant liquid was removed by decantation, and the remainder was washed with 500 g of ion-exchanged water until it was neutral. The ion-exchanged water was removed by decantation; the remainder was washed with 200 g of a 1% hydrogen peroxide/EDTA solution to remove the excess sulfide. Then, the product was further washed with ion-exchanged water until it was neutral, followed by drying under a vacuum of 1.3 kPa or lower at 100° C. for 12 hours to obtain 9.2 g of a second sintered product. The optical excitation fluorescence spectrum of the second sintered product (zinc sulfide phosphor) was measured. The fluorescence quantum yield of zinc sulfide phosphor is shown in Table 2.

To 1.5 g of the obtained zinc sulfide phosphor, 1.0 g of fluorine binder (7155 produced by DuPont) was added as a binder, and the ingredients were mixed and degassed to prepare an emission layer paste. An emission layer having 40 μm thick was printed on an ITO coated PET film (product name: KB300N-125 produced by Oike & Co., Ltd.) with the emission layer paste, using a 20 mm×20 mm screen printing plate (200 mesh, 25 μm). A barium titanate paste (7153 produced by DuPont) was further printed on the upper surface of the emission layer using a screen printing plate (150 mesh, 25 μm), dried at 100° C. for 10 minutes, then printed again and dried at 100° C. for 10 minutes to deposit a dielectric layer that is 20 μm thick. A screen printing plate (150 mesh, 25 μm) was used to print a silver paste (461SS produced by Acheson) as an electrode on the upper surface of the dielectric layer, then dried at 100° C. for 10 minutes to deposit the electrode and form a powder type EL element. The powder EL element was set on the sample measurement position of FP-6500 produced by JASCO Corporation, and electricity was applied at 200 V and 1 kHz to induce luminescence of the powder type EL element. The emitted light was measured with the fluorescence spectrophotometer to obtain the luminescence spectrum and luminance, and perform chromaticity conversion to obtain the y value. The result is shown in Table 2.

### Example 2

The process of Example 1 was followed, except that the amount of nickel sulfate hexahydrate was changed to 4.4 mg (corresponding to 10 ppm of Ni), to prepare and sinter a zinc sulfide phosphor precursor. The luminescent quantum yield, luminance and chromaticity were measured for the sintered product, as in Example 1. Results are shown in Table 1 and Table 2.

### Example 3

The process of Example 1 was followed, except that the amount of nickel sulfate hexahydrate was changed to 0.4 mg (corresponding to 1 ppm of Ni), to prepare and sinter a zinc sulfide phosphor precursor. The luminescent quantum yield, luminance and chromaticity were measured for the sintered product, as in Example 1. Results are shown in Table 1 and Table 2.

### Example 4

The process of Example 1 was followed, except that the amount of copper sulfate pentahydrate to be added to the zinc chloride anhydride was changed to 0.12 g (corresponding to 300 ppm of Cu), to prepare and sinter a zinc sulfide phosphor precursor. The luminescent quantum yield, luminance and chromaticity were measured for the sintered product, as in Example 1. Results are shown in Table 1 and Table 2.

### Example 5

The process of Example 1 was followed, except that the nickel sulfate hexahydrate was replaced with 3.7 mg of iron chloride (III) hexahydrate (corresponding to 8 ppm of Fe), to prepare and sinter a zinc sulfide phosphor precursor. The luminescent quantum yield, luminance and chromaticity were measured for the sintered product, as in Example 1. Results are shown in Table 1 and Table 2.

### Example 6

The process of Example 1 was followed, except that the nickel sulfate hexahydrate was replaced with 9.4 mg of iron chloride (III) hexahydrate (corresponding to 20 ppm of Fe), to prepare and sinter a zinc sulfide phosphor precursor. The luminescent quantum yield, luminance and chromaticity were measured for the sintered product, as in Example 1. Results are shown in Table 1 and Table 2.

### Example 7

The process of Example 4 was followed, other than that the nickel sulfate hexahydrate was replaced with 3.7 mg of iron chloride (III) hexahydrate (corresponding to 8 ppm of Fe), to prepare and sinter a zinc sulfide phosphor precursor. The luminescent quantum yield, luminance and chromaticity were measured for the sintered product, as in Example 4. Results are shown in Table 1 and Table 2.

### Example 8

The process of Example 2 was followed, except that 3.7 mg of iron chloride (III) hexahydrate (corresponding to 8 ppm of Fe) was further added, to prepare and sinter a zinc sulfide phosphor precursor. The luminescent quantum yield, luminance and chromaticity were measured for the sintered product, as in Example 2. Results are shown in Table 1 and Table 2.

### Comparative Example 1

The process of Example 1 was followed, except that the nickel sulfate hexahydrate was not added, to prepare and sinter a zinc sulfide phosphor precursor. The luminescent quantum yield, luminance and chromaticity were measured for the sintered product, as in Example 1. Results are shown in Table 1 and Table 2.

### Comparative Example 2

The process of Example 4 was followed, except that the nickel sulfate hexahydrate was not added, to prepare and sinter a zinc sulfide phosphor precursor. The luminescent quantum yield, luminance and chromaticity were measured for the sintered product, as in Example 4. Results are shown in Table 1 and Table 2.

### Example 9

The process of Example 1 was followed, except that 13.2 mg of nickel sulfate hexahydrate was added (corresponding to 30 ppm of Ni), to prepare and sinter a zinc sulfide phosphor precursor. The luminescent quantum yield, luminance and chromaticity were measured for the sintered product, as in Example 1. Results are shown in Table 1 and Table 2.

### Example 10

The process of Example 6 was followed, except that 40.6 mg of iron chloride (III) hexahydrate was added (corresponding to 80 ppm of Fe), to prepare and sinter a zinc sulfide phosphor precursor. The luminescent quantum yield, luminance and chromaticity were measured for the sintered product, as in Example 6. Results are shown in Table 1 and Table 2.

### Comparative Example 3

The process of Example 1 was followed, except that 1.81 g of manganese acetate was added (corresponding to 4500 ppm of Mn) in place of 0.19 g of copper sulfate pentahydrate, to prepare and sinter a zinc sulfide phosphor precursor. The luminescent quantum yield, luminance and chromaticity were measured for the sintered product, as in Example 1. Results are shown in Table 1 and Table 2.

### Reference Example 1

The process of Example 1 was followed, except that 1.81 g of manganese acetate was added (corresponding to 4500 ppm of Mn) in place of 0.19 g of copper sulfate pentahydrate, and that nickel sulfate hexahydrate was not added, to prepare and sinter a zinc sulfide phosphor precursor. The luminescent quantum yield, luminance and chromaticity were measured for the sintered product, as in Example 1. Results are shown in Table 1 and Table 2.

TABLE 1

| | copper | manganese | nickel | iron |
|---|---|---|---|---|
| | content | content | content | content |
| | (ppm) | (ppm) | (ppm) | (ppm) |
| Example 1 | 507 | 0 | 3.3 | 0 |
| Example 2 | 508 | 0 | 8.3 | 0 |
| Example 3 | 506 | 0 | 0.9 | 0 |
| Example 4 | 302 | 0 | 3.1 | 0 |
| Example 5 | 501 | 0 | 0 | 6.9 |
| Example 6 | 503 | 0 | 0 | 18.4 |
| Example 7 | 303 | 0 | 0 | 7.1 |
| Example 8 | 507 | 0 | 8.2 | 6.1 |
| Example 9 | 502 | 0 | 23.4 | 0 |
| Example 10 | 499 | 0 | 0 | 53.7 |
| Comparative Example 1 | 508 | 0 | 0 | 0 |
| Comparative Example 2 | 303 | 0 | 0 | 0 |
| Comparative Example 3 | 0 | 4180 | 2.4 | 0 |
| Reference Example 1 | 0 | 4210 | 0 | 0 |

TABLE 2

| | fluorescence | luminance | chromaticity |
|---|---|---|---|
| | quantum yield (%) | (Cd/m3) | (y value) |
| Example 1 | 36 | 306 | 0.145 |
| Example 2 | 21 | 268 | 0.136 |
| Example 3 | 45 | 332 | 0.150 |
| Example 4 | 31 | 297 | 0.091 |
| Example 5 | 43 | 312 | 0.152 |
| Example 6 | 41 | 308 | 0.158 |
| Example 7 | 37 | 288 | 0.141 |
| Example 8 | 19 | 256 | 0.130 |
| Example 9 | 2 | 7 | 0.101 |
| Example 10 | 1 | 3 | 0.111 |
| Comparative Example 1 | 56 | 336 | 0.175 |
| Comparative Example 2 | 54 | 312 | 0.161 |
| Comparative Example 3 | 24.3 | 0 | — |
| Reference Example 1 | 54.7 | 0 | |

Table 2 shows that the chromaticity (y value) of a zinc sulfide phosphor precursor having nickel or iron added during its production is lower than those of the comparative examples with the same level of copper content, and that the color tone of the EL luminescence is bluer. The Examples of the present invention produced zinc sulfide phosphors whose green tone was reduced and blue tone was enhanced.

1. A zinc sulfide blue phosphor comprising copper, silver or both elements, and nickel, iron or both elements.

2. The zinc sulfide blue phosphor according to claim 1, wherein a content of nickel is not lower than 0.1 ppm and not higher than 20 ppm.

3. The zinc sulfide blue phosphor according to claim 1 or 2, wherein a content of iron is not lower than 0.1 ppm and not higher than 50 ppm.

4. The zinc sulfide blue phosphor according to any one of claims 1 to 3, wherein a powder EL element is composed of the phosphor, and a y value of an emission color when the elements are driven at 200V and 1 kHz is 0.07≦y≦0.16.

5. A method of producing zinc sulfide blue phosphor according to any one of claims 1 to 4 comprising:
adding a compound comprising copper, silver or both elements, a zinc compound, a sulfidizing agent and a compound comprising nickel, iron or both elements as one or more aqueous solutions to an organic solvent to form a liquid reaction mixture;
heating the liquid reaction mixture and removing water from the reaction mixture by azeotropic dehydration of water and the organic solvent to obtain a zinc sulfide phosphor precursor; and
further sintering the zinc sulfide phosphor precursor.
